(19) United States
(12) Patent Application Publication
(10) Pub. No.: US 2026/0317626 A1
(43) Pub. Date: Oct. 15, 2026

(54) High Flow Liquid Crystalline Polymer Composition

(71) Applicant: Ticona LLC, Florence, KY (US)

(72) Inventors: Shuai Xu, Shanghai (CN); Young Shin Kim, Cincinnati, OH (US); Fangfang Tao, Shanghai (CN)

(21) Appl. No.: 19/522,304

(22) PCT Filed: Dec. 19, 2023
(86) PCT No.: PCT/CN2023/139741

§ 371 Date: Mar. 24, 2026

(51) Int. Cl. C09K 19/52

(52) U.S. Cl. CPC C09K 19/52; C09K 2019/521

(57) ABSTRACT

A polymer composition comprising flake-shaped particles distributed within a polymer matrix is provided. The flake-shaped particles have an aspect ratio of about 3 or more and the polymer matrix includes a thermotropic liquid crystalline polymer. The polymer composition exhibits a melt viscosity of about 35 Pa-s or less (shear rate of 1,000 seconds⁻¹ and temperature that is 15° C. higher than the melting temperature) and a tensile elongation of about 2.5% or more.

### BACKGROUND OF THE INVENTION

Electrical components (e.g., fine pitch connectors) are commonly produced from wholly aromatic thermotropic liquid crystalline polymers (“LCPs”). One benefit of such polymers is that they can exhibit a relatively high “flow”, which refers to the ability of the polymer when heated under shear to uniformly fill complex parts at fast rates without excessive flashing or other detrimental processing issues. In addition to enabling complex part geometries, high polymer flow can also enhance the ultimate performance of the molded component. Most-notably, parts generated from well-flowing polymers generally display improved dimensional stability owing to the lower molded-in stress, which makes the component more amenable to downstream thermal processes that can be negatively impacted from warpage and other polymer stress relaxation processes that occur in less well-molded materials. Despite their relatively high flow capacity, current commercial LCPs still fall short of what is needed to meet the increased molding demands of intricate part designs without significant compromises to the final product performance. In this regard, various attempts have been made to improve the flow properties of conventional polymers by lowering their melt viscosity. One approach to a lower melt viscosity has involved the use of certain types of additives. Such additives, however, particularly when used in relatively high amounts, can result in the formation of volatile products due to their decomposition during melt processing and/or use. This may, in turn, lead to the formation of blisters that can adversely impact the thermal and mechanical properties of the polymer and thus limit its use in certain applications.

As such, a need exists for a liquid crystalline thermoplastic composition that has an ultralow melt viscosity, and yet still attain good mechanical properties.

### SUMMARY OF THE INVENTION

In accordance with one embodiment of the present invention, a polymer composition is disclosed that comprises flake-shaped particles distributed within a polymer matrix. The flake-shaped particles have an aspect ratio of about 3 or more and the polymer matrix includes a thermotropic liquid crystalline polymer. The polymer composition exhibits a melt viscosity of about 35 Pa-s or less as determined in accordance with ISO 11443:2021 at a shear rate of 1,000 seconds⁻¹ and temperature that is 15° C. higher than the melting temperature of the composition. Further, the polymer composition exhibits a tensile elongation of about 2.5% or more as determined in accordance with ISO 527:2019 at a temperature of 23° C.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1A depicts a thin walled electrical connector according to aspects of present invention;

FIG. 1B depicts an enlarged view of a portion of thin walled connector of FIG. 1A; and

FIG. 2 is an exploded perspective view of another embodiment of a thin walled connector and connector receptacle that may be formed according to the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition that contains a polymer matrix and flaked-shaped particles distributed within the polymer matrix. Through careful control over the specific nature and concentration of the components employed in the composition, the present inventor has discovered that the resulting composition can be formed that has a unique combination of an ultralow melt viscosity (high flow) and excellent mechanical properties (e.g., flexibility and strength), which can enable its use in certain types of ultrathin electronic components. For example, the polymer composition may have a melt viscosity of about 35 Pa-s or less, in some embodiments from about 1 to about 30 Pa-s, and in some embodiments, from about 2 to about 25 Pa-s, as determined at a shear rate of 1,000 seconds⁻¹ in accordance with ISO 11443:2021 at a temperature that is 15° C. higher than the melting temperature of the composition (e.g., about 340° C. for a melting temperature of about 325° C.). Despite having such a low melt viscosity, the tensile elongation (i.e., flexibility) may remain relatively high, such as about 2.5% or more, in some embodiments about 3% or more, in some embodiments about 3.1% or more, and in some embodiments, about 3.2% or more, as determined in accordance with ISO 527:2019 at a temperature of 23° C. The polymer composition may also exhibit other excellent mechanical properties. For example, the composition may exhibit a relatively low tensile and/or flexural modulus, which allows it to remain relatively flexible and less likely to break once molded into a thin part (e.g., thin connector). The tensile modulus may, for instance, be about 14,000 MPa or less, in some embodiments about 13,000 MPa or less, and in some embodiments, from about 5,000 MPa to about 12,000 MPa as determined in accordance with ISO 527:2019 at a temperature of 23° C. The flexural modulus may likewise be about 14,000 MPa or less, in some embodiments about 13,000 MPa or less, and in some embodiments, from about 5,000 MPa to about 12,000 MPa as determined in accordance with ISO 178:2019 at a temperature of 23° C.

Of course, the polymer composition may also exhibit other good strength properties. For example, the composition may exhibit a tensile strength of about 90 MPa or more, in some embodiments about 100 MPa or more, in some embodiments from about 105 MPa to about 350 MPa, and in some embodiments, from about 110 MPa to about 250 MPa, as determined in accordance with ISO 527:2019 at a temperature of 23° C. The composition may likewise exhibit a flexural strength of about 80 MPa or more, in some embodiments from about 100 MPa to about 350 MPa, and in some embodiments, from about 120 MPa to about 250 MPa and/or a flexural elongation of about 0.5% or more, in some embodiments from about 0.6% to about 3.5%, and in some embodiments, from about 0.8% to about 3%, as determined in accordance with ISO 178:2019 at a temperature of 23° C. The impact strength may also be good. For example, the composition may exhibit a Charpy notched impact strength of about 1 KJ/m² or more, in some embodiments from about 1.5 to about 10 KJ/m², and in some embodiments, from about 2 to about 80 KJ/m², measured at 23° C. according to ISO Test No. 179-1:2010.

The polymer composition may also exhibit good thermal properties, such as a high melting temperature, such as from about 300° C. to about 400° C., in some embodiments from about 310° C. to about 380° C., and in some embodiments, from about 315° C. to about 350° C. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.7 to about 0.95, and in some embodiments, from about 0.75 to about 0.9. The specific DTUL values may, for instance, be 240° C. or more, in some embodiments about 245° C. or more, in some embodiments about 250° C. or more, and in some embodiments, from about 255° C. to about 320° C. Such high DTUL values can, among other things, allow the use of high speed and reliable surface mounting processes for mating the structure with other components of the electrical component. The heat resistance of the polymer composition may also be reflected by the “blister-free temperature”, as described in more detail below, which may be about 250° C. or more, in some embodiments about 255° C. or more, and in some embodiments, from about 260° C. to about 290° C.

Various embodiments of the present invention will now be described in more detail.

### I. Polymer Composition

### A. Polymer Matrix

The polymer matrix typically contains one or more liquid crystalline polymers, generally in an amount of from about 20 wt. % to about 80 wt. %, in some embodiments from about 30 wt. % to about 75 wt. %, and in some embodiments, from about 40 wt. % to about 70 wt. % of the polymer composition. The liquid crystalline polymers are generally classified as “thermotropic” to the extent that they can possess a rod-like structure and exhibit a crystalline behavior in their molten state (e.g., thermotropic nematic state). The polymers may have a relatively high melting temperature and low melt viscosity, such as within the ranges described above. Such polymers may be formed from one or more types of repeating units as is known in the art. A liquid crystalline polymer may, for example, contain one or more aromatic ester repeating units generally represented by the following Formula (I):

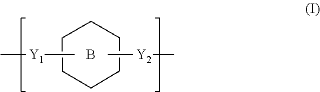

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and
Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl) ether, bis(4-carboxyphenyl)butane, bis(4-carboxyphenyl)ethane, bis(3-carboxyphenyl) ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”).

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

The specific monomers and molar concentrations of the liquid crystalline polymer(s) may be selected to help achieve the desired combination of low melt viscosity and good mechanical properties as discussed herein. In one particular embodiment, for example, the liquid crystalline polymer may contain from about 20 mol. % to about 60 mol. % of a repeating unit represented by Formula (I), from 0 mol. % to about 20 mol. % of a repeating unit represented by Formula (II), from about 5 mol. % to about 45 mol. % of a repeating unit represented by Formula (III), from about 5 mol. % to about 40 mol. % of a repeating unit represented by Formula (IV), and from 0 mol. % to about 15 mol. % of a repeating unit represented by Formula (V):

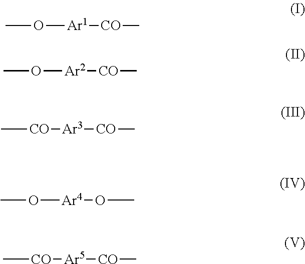

wherein,
Ar¹, Ar⁴, and Ar⁵ independently represent a phenyl or a biphenyl group, optionally substituted with a halogen atom, an alkyl group having 1 to 10 carbon atoms, or an aryl group having 6 to 20 carbon atoms; and
Ar² and Ar³ independently represent a naphthenyl group optionally substituted with a halogen atom, an alkyl group having 1 to 10 carbon atoms, or an aryl group having 6 to 20 carbon atoms.

If desired, the molar ratio of the repeating unit represented by Formula (IV) (e.g., HQ and/or BP) to the total of repeating units represented by Formula (IIII) (e.g., NDA) and Formula (V) (e.g., TA and/or IA) may be greater than 1, and in some embodiments, from about 1.05 to about 1.5. In this manner, the diol monomers are present in a slight molar excess to help achieve the desired properties of the polymer. Furthermore, while other monomeric constituents may certainly be employed, the total molar percentage of the repeating units represented by Formulae (I), (II), (III), (IV), and (V) may equal 100% in certain embodiments.

In particular embodiments, for example, the liquid crystalline polymer may contain from about 30 mol. % to about 55 mol. %, and in some embodiments, from about 35 mol % to about 50 mol. % of a repeating unit represented by Formula (I) (e.g., HBA); from about 10 mol. % to about 40 mol. %, and in some embodiments, from about 15 mol % to about 30 mol. % of a repeating unit represented by Formula (III) (e.g., NDA); from about 10 mol. % to about 35 mol. %, and in some embodiments, from about 20 mol % to about 30 mol. % of a repeating unit represented by Formula (IV) (e.g., HQ and/or BP); and from about 2 mol. % to about 12 mol. %, and in some embodiments, from about 3 mol. % to about 10 mol. % of a repeating unit represented by Formula (V) (e.g., TA and/or IA). Further, in certain embodiments, the total molar percentage of the repeating units represented by Formulae (I), (III), (IV), and (V) equals 100%.

Regardless of the particular constituents, the liquid crystalline polymer(s) may be prepared by initially introducing the aromatic monomer(s) used to form the ester repeating units (e.g., aromatic hydroxycarboxylic acid, aromatic dicarboxylic acid, etc.) and/or other repeating units (e.g., aromatic diol, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation. In addition to the monomers and optional acetylating agents, other components may also be included within the reaction mixture to help facilitate polymerization. For instance, a catalyst may be optionally employed, such as metal salt catalysts (e.g., magnesium acetate, tin (I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 200° C. to about 400° C. For instance, one suitable technique for forming a liquid crystalline polymer may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 200° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Generally speaking, the molten polymer is discharged from the reactor at a point in which the desired melt viscosity is achieved. As is known in the art, this may be correlated to the torque of the agitator. For example, after the torque of the agitator reaches a predetermined value, nitrogen may be introduced into the reactor so as to convert reduced pressure conditions to pressurized conditions via atmospheric pressure, thereby discharging the resultant polymer from the reactor, typically through an extrusion orifice fitted with a die of desired configuration, cooled, and collected. Commonly, the melt is discharged through a perforated die to form strands that are taken up in a water bath, pelletized and dried.

Although not always required or desired, the melt polymerized polymer may also be subjected to a subsequent solid-state polymerization method to further increase its molecular weight and achieve the desired melt viscosity. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 200° C. to about 400° C. The polymerization time will of course vary based on the temperature and target molecular weight. In most cases, however, the solid-state polymerization time will be from about 2 to about 12 hours, and in some embodiments, from about 4 to about 10 hours.

### B. Flaked-Shaped Glass Particles

As indicated above, flaked-shaped particles are also employed in the polymer composition. Typically, the flaked-shaped particles constitute from about 10 to about 80 parts by weight, in some embodiments from about 25 to about 75 parts by weight, and in some embodiments, from about 40 to about 70 parts by weight per 100 parts by weight of the polymer matrix. For example, flaked-shaped particles may constitute from about 10 wt. % to about 50 wt. %, in some embodiments from about 15 wt. % to about 45 wt. %, and in some embodiments, from about 20 wt. % to about 40 wt. % of the polymer composition.

The flaked-shaped particles generally have a relatively high aspect ratio (e.g., average diameter divided by nominal thickness), such as about 3 or more, in some embodiments about 5 or more, in some embodiments about 10 or more, and in some embodiments, from about 50 to about 500. The average diameter (D50) of the particles may, for example, range from about 1 micrometers to about 300 micrometers, in some embodiments from about 5 micrometers to about 250 micrometers, and in some embodiments, from about 15 micrometers to about 200 micrometers. The nominal thickness may likewise range from about 0.1 to about 10 micrometers, in some embodiments from about 0.2 to about 8 micrometers, and in some embodiments, from about 0.3 nanometers to about 5 micrometers. The diameter and/or thickness may be determined using any suitable technique known in the art, such as by laser diffraction techniques in accordance with ISO 13320:2020 (e.g., with a Horiba LA-960 particle size distribution analyzer). The flaked-shaped particles may be formed from an inorganic material, such as glass, natural and/or synthetic silicate minerals, such as mica, halloysite, kaolinite, illite, montmorillonite, vermiculite, palygorskite, pyrophyllite, calcium silicate, aluminum silicate, wollastonite, etc. In certain embodiments, however, it may be preferable to employ glass flake-shaped particles to help achieve a higher degree of flexibility, as represented by a low tensile modulus and high tensile elongation. The glass flaked-shaped particles may be formed from E-glass, E-CR-glass, A-glass, C-glass, D-glass, AR-glass, R-glass, S1-glass, S2-glass, etc., as well as mixtures thereof.

### C. Optional Fillers

If desired, reinforcing fibers may also be employed in the polymer composition, such as polymer fibers, metal fibers, carbonaceous fibers (e.g., graphite, carbide, etc.), inorganic fibers, etc., as well as combinations thereof. Inorganic fibers may be particularly suitable, such as those that are derived from glass, such as described above. The fibers may be generally symmetrical in nature (e.g., square, circular, etc.) such that the aspect ratio of from about 0.8 to about 1.5, in some embodiments from about 0.85 to about 1.4, and in some embodiments, from about 0.9 to about 1.2. The aspect ratio is determined by dividing the diameter of the fibers by the cross-sectional thickness of the fibers. In other embodiments, however, it may be desirable to use fibers that have a relatively flat cross-sectional dimension in that they have an aspect ratio of from about 1.5 to about 10, in some embodiments from about 2 to about 8, and in some embodiments, from about 3 to about 5. The shape of such fibers may be in the form of an ellipse, rectangle, rectangle with one or more rounded corners, etc. Regardless of the particular shape, the average diameter of the fibers may be from about 1 to about 50 micrometers, in some embodiments from about 5 to about 45 micrometers, and in some embodiments, from about 10 to about 35 micrometers. The fibers may be endless, chopped, or milled fibers. Particularly suitable are milled fibers having a number average length (prior to melt processing) of from about 5 to about 200 micrometers, in some embodiments from about 10 to about 150 micrometers, and in some embodiments, from about 20 to about 100 micrometers. The diameter and/or length may be determined using any suitable technique known in the art, such as by laser diffraction techniques in accordance with ISO 13320:2020 (e.g., with a Horiba LA-960 particle size distribution analyzer).

When employed, the amount of reinforcing fibers may be selectively controlled to help achieve the desired combination of flow and good mechanical properties. The reinforcing fibers may, for example, be employed in an amount of from about 1 to about 80 parts, in some embodiments from about 5 to about 60 parts, and in some embodiments, from about 10 to about 50 parts per 100 parts by weight of the polymer matrix. The reinforcing fibers may, for instance, constitute from about 1 wt. % to about 40 wt. %, in some embodiments from about 2 wt. % to about 30 wt. %, and in some embodiments, from about 5 wt. % to about 20 wt. % of the polymer composition.

If desired, the polymer composition may also contain granular particles that are distributed within the polymer matrix, such as talc, barium sulfate, calcium sulfate, calcium carbonate, etc. When employed, such particles may constitute from about 1 to about 100 parts by weight, in some embodiments from about 2 to about 85 parts by weight, in some embodiments from about 20 to about 80 parts by weight, and in some embodiments, from about 5 to about 70 parts by weight per 100 parts by weight of the polymer matrix. For example, the granular particles may constitute from about 5 wt. % to about 50 wt. %, in some embodiments from about 8 wt. % to about 40 wt. %, and in some embodiments, from about 10 wt. % to about 35 wt. % of the polymer composition. The granular particles may have a median diameter of from about 0.1 to about 20 micrometers, in some embodiments from about 0.5 to about 18 micrometers, in some embodiments from about 1 to about 15 micrometers, in some embodiments from about 1.5 to about 10 micrometers, and in some embodiments, from about 2 to about 8 micrometers, such as determined using laser diffraction techniques in accordance with ISO 13320:2020 (e.g., with a Horiba LA-960 particle size distribution analyzer) and/or by sedimentation analysis (e.g., Sedigraph 5120). If desired, the particles may also have a high specific surface area, such as from about 1 square meters per gram (m²/g) to about 50 m²/g, in some embodiments from about 1.5 m²/g to about 25 m²/g, and in some embodiments, from about 2 m²/g to about 15 m²/g. Surface area may be determined by the physical gas adsorption (BET) method (nitrogen as the adsorption gas) in accordance with DIN 66131:1993. The moisture content may also be relatively low, such as about 5% or less, in some embodiments about 3% or less, and in some embodiments, from about 0.1 to about 1% as determined in accordance with ISO 787-2:1981 at a temperature of 105° C.

### D. Other Optional Components

A wide variety of additional additives can also be included in the polymer composition, such as flow modifiers, impact modifiers, lubricants, pigments (e.g., carbon black), antioxidants, stabilizers, surfactants, waxes, flame retardants, nucleating agents (e.g., boron nitride), electrically conductive fillers, and other materials added to enhance properties and processability. Lubricants, for example, may be employed in the polymer composition in an amount from about 0.05 wt. % to about 1.5 wt. %, and in some embodiments, from about 0.1 wt. % to about 0.5 wt. % (by weight) of the polymer composition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide.

Due to the relatively low melt viscosity of the liquid crystalline polymer(s) employed in the polymer composition, it is generally not necessary to include conventional flow modifiers within the composition. In fact, it may be preferred to exclude such flow modifiers to help ensure that the desired properties are achieved. Nevertheless, such flow modifiers may sometimes be employed in the polymer composition. For example, the liquid crystalline polymer(s) employed in the polymer matrix may be formed by a process that includes melt processing the liquid crystalline polymer(s) in the presence of a flow modifier. When employed, however, the flow modifiers typically constitute less than about 3 parts by weight, in some embodiments from about 0.01 to about 2 parts by weight, and in some embodiments, from about 0.5 to about 1.5 parts by weight per 100 parts by weight of the polymer matrix. Examples of suitable flow modifiers may include, for instance, carboxylic acids (e.g., 2,6-naphthalene-dicarboxylic acid), metal hydroxides, etc. The metal hydroxide may, for instance, have the general formula M(OH)ₐO_{b}, where 0≤a≤3 (e.g., 3) and b=(3−a)/2, where M is a metal, such as a transition metal (e.g., copper), alkali metal (e.g., potassium sodium, etc.), alkaline earth metal (e.g., calcium, magnesium, etc.), post-transition group metal (e.g., aluminum), and so forth. Particularly suitable metals include aluminum and magnesium. Examples of suitable metal hydroxides may include, for instance, copper (II) hydroxide (Cu(OH)₂), potassium hydroxide (KOH), sodium hydroxide (NaOH), magnesium hydroxide (Mg(OH)₂), calcium hydroxide (Ca(OH)₂), aluminum hydroxide (Al(OH)₃), and so forth. The metal hydroxide is typically in the form of particles. In one particular embodiment, for example, the metal hydroxide particles include aluminum hydroxide and optionally exhibit a gibbsite crystal phase. The particles may have a relatively small size, such as a median diameter of from about 50 nanometers to about 3,000 nanometers, in some embodiments from about 100 nanometers to about 2,000 nanometers, and in some embodiments, from about 500 nanometers to about 1,500 nanometers. The term “median” diameter as used herein refers to the “D50” size distribution of the particles, which is the point at which 50% of the particles have a smaller size. The particles may likewise have a D90 size distribution within the ranges noted above. The diameter of particles may be determined using known techniques, such as by ultracentrifuge, laser diffraction, etc. For example, particle size distribution can be determined with laser diffraction according to ISO 13320:2020.

### II. Formation

The components of the polymer composition may be melt processed or blended together. The components may be supplied separately or in combination to an extruder that includes at least one screw rotatably mounted and received within a barrel (e.g., cylindrical barrel) and may define a feed section and a melting section located downstream from the feed section along the length of the screw. The extruder may be a single screw or twin screw extruder. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

### III. Product Applications

Generally speaking, the polymer composition is well suited for use in a wide variety of product applications, such as electrical connectors, camera modules, etc. Examples of products that may contain such electronic components (e.g., connector, camera module, etc.) may include, for instance, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, camera modules, integrated circuits (e.g., SIM cards), housings for electronic devices, electrical controls, circuit breakers, switches, power electronics, printer parts, etc.

When employed in an electrical connector, for instance, the connector may have a variety of configurations. As an example, the electrical connector can define a plurality of passageways or spaces between opposing walls. The passageways can accommodate contact pins to facilitate a large number of distinct electrical connections with the pins. The electrical connector can also be very compact as a result of the polymer composition from which it is formed. For example, the polymer composition may exhibit excellent flow characteristics for forming very small features required to form the electrical connector described herein while also exhibiting minimal warpage when exposed to heat. In this regard, the walls can have respective widths “w” that are relatively thin, such as about 500 micrometers or less, in some embodiments about 400 micrometers or less, in some embodiments from about 25 micrometers to about 350 micrometers, and in some embodiments from about 50 micrometers to about 300 micrometers.

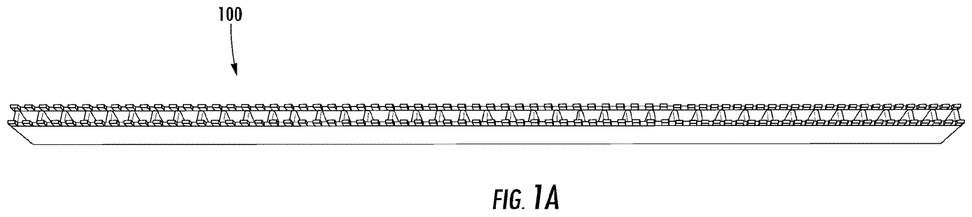

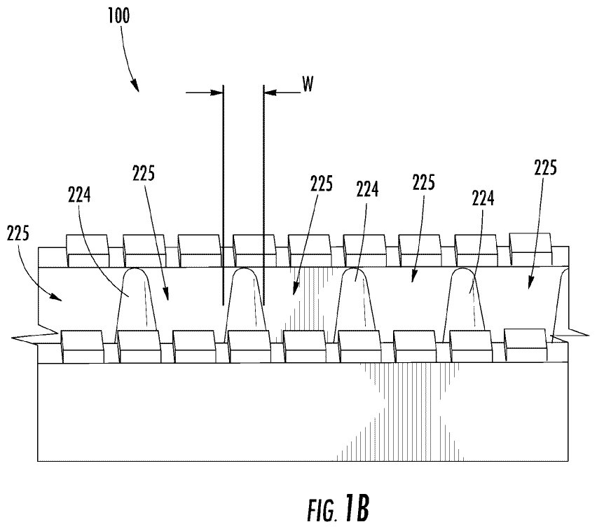

One particularly suitable electrical connector 100 is shown in FIG. 1A according to aspects of the present invention. FIG. 1B depicts an enlarged view of the electrical connector 100 of FIG. 1A. As illustrated, insertion passageways or spaces 225 are defined between opposing walls 224 that can accommodate contact pins to facilitate a large number of distinct electrical connections. The electrical connector 100 can be very compact. More specifically, the walls 224 can have respective widths “w” that are relatively thin, such as within the ranges described above.

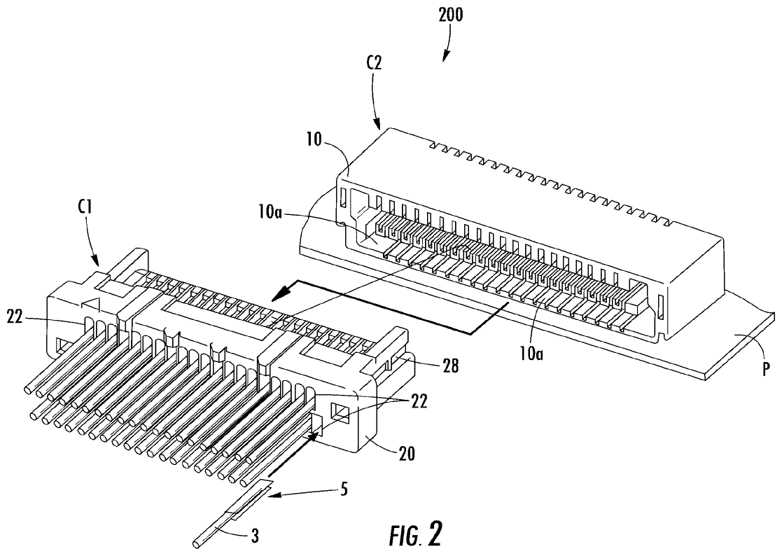

Another embodiment an electrical connector 200 is depicted in FIG. 2. A board-side portion C2 that can be mounted onto the surface of a circuit board P. The connector 200 may also include a wiring material-side portion C1 structured to connect discrete wires 3 to the circuit board P by being coupled to the board-side connector C2. The board-side portion C2 may include a first housing 10 that has a fitting recess 10a into which the wiring material-side connector C1 is fitted and a configuration that is slim and long in the widthwise direction of the housing 10. The wiring material-side portion C1 may likewise include a second housing 20 that is slim and long in the widthwise direction of the housing 20. In the second housing 20, a plurality of terminal-receiving cavities 22 may be provided in parallel in the widthwise direction so as to create a two-tier array including upper and lower terminal-receiving cavities 22. A terminal 5, which is mounted to the distal end of a discrete wire 3, may be received within each of the terminal-receiving cavities 22. If desired, locking portions 28 (engaging portions) may also be provided on the housing 20 that correspond to a connection member (not shown) on the board-side connector C2.

As discussed above, the interior walls of the first housing 10 and/or second housing 20 may be relatively thin (e.g., may have a relatively small width dimension), and can be formed from the polymer composition of the present invention. Of course, the polymer composition may also be employed in any other portion of the connector. Regardless of the portion, the polymer composition may be molded to form the desired shape of the portion (e.g., walls) using known techniques, such as injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

The present invention may be better understood with reference to the following examples and test methods.

### Test Methods

Melt Viscosity: The melt viscosity (Pa-s) may be determined in accordance with ISO 11443:2021 at a shear rate of 400 or 1,000 s⁻¹ and temperature 15° C. above the melting temperature using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod may be 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO 11357-3:2018. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO 75-2:2013 (technically equivalent to ASTM D648). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO 75-2:2013).

Tensile Modulus, Tensile Stress, and Tensile Elongation: Tensile properties may be tested according to ISO 527:2019 (technically equivalent to ASTM D638). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO 178:2019 (technically equivalent to ASTM D790). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010 (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Blister-Free Temperature: To test blister resistance, a 127×12.7×0.8 mm test bar may be molded at 5° C. to 10° C. higher than the melting temperature of the polymer resin, as determined by DSC. Ten (10) bars are then placed through a heating chamber of a reflow oven at a predetermined temperature profile, subsequently removed, cooled to ambient conditions, and then inspected for blisters (i.e., surface deformations) that may have formed. The predetermined temperature profile begins at 250° C. and is increased at 10° C. increments until a blister is observed on one or more of the test bars. The highest temperature at which all ten (10) bars exhibit no observable blisters is identified as the “blister free temperature” for a tested material.

### Comparative Examples 1-3

Comparative Examples 1-3 are formed from various percentages of a first liquid crystalline polymer (“LCP 1”), second liquid crystalline polymer (“LCP 2”), glass fibers (Chopped Glass or Milled Glass), talc, black concentrate (“Carbon Black MB”), lubricant, and/or flow modifiers, as set forth below in Table 1.

LCP 1 is formed from 42.8% HBA, 8.5% TA, 28.6% HQ, and 20% NDA, and has a melting temperature of about 325° C. and DTUL of about 257° C. LCP 1 is formed by charging the aforementioned monomers into a polymerization reactor in combination with an acetylating agent (e.g., acetic anhydride), heating the mixture to acetylize the monomers, and then increasing the temperature to carry out melt polycondensation. The molten polymer is discharged from the reactor at a point in which the extruder torque correlates to a target melt viscosity of about 35-55 Pa-s (1000 s⁻¹). LCP 2 is formed with the same monomer content as LCP 1, but has a melting temperature of about 320-325° C. and is formed by subjecting LCP 1 to a solid-stated polymerization process until a target melt viscosity of about 15-25 Pa-s (1000 s⁻¹) is achieved. The Chopped Glass had a diameter of 9-13 μm and average length of about 3,000 μm, and the Milled Glass had an average diameter of about 9-13 μm and an average length of about 50-150 μm. The Carbon Black MB contained 20 wt. % carbon black and 85 wt. % of a third liquid crystalline polymer (“LCP 3”). LCP 3 is formed from 60% HBA, 5% HNA, 12.5% BP, 17.5% TA, and 5% APAP, and has a melting temperature of about 338° C. and DTUL of about 235° C.

TABLE 1
Formulations

| | Comp. Ex. 1 | Comp. Ex. 2 | Comp. Ex. 3 |
|---|---|---|---|
| LCP 1 | 50.3 | 51.8 | — |
| LCP 2 | — | — | 52.3 |
| LCP 3 | 1.5 | — | — |
| Chopped Glass | 45 | — | 45 |
| Milled Glass | — | 15 | — |
| Talc | — | 30 | — |
| Black Concentrate | 2.5 | 2.5 | 2.5 |
| Lubricant | 0.2 | 0.2 | 0.2 |
| Flow Modifiers | 0.5 | 0.5 | — |

Comparative Examples 1-3 were tested for certain thermal and mechanical properties. The results are set forth below in Table 2.

TABLE 2
Thermal and Mechanical Properties

| | Comp. | Comp. | Comp. |
|---|---|---|---|
| | Ex. 1 | Ex. 2 | Ex. 3 |
| Melt Viscosity at 1,000 s⁻¹ (Pa-s) | 35.4 | 35.9 | 33.6 |
| Charpy Notched Strength (kJ/m²) | 23.4 | 3.6 | 29.5 |
| Blister Free Temperature (° C.) | 265 | 265 | 265 |
| Tensile Strength (MPa) | 109.03 | 97.06 | 93.58 |
| Tensile Modulus (MPa) | 14,017 | 10,196 | 12,813 |
| Tensile Elongation (%) | 2.84 | 3.07 | 2.28 |

### Examples 1-2

Examples 1-2 are formed from various percentages of LCP 2, Milled Glass, flaked-shaped particles (Mica or Glass Flakes), Carbon Black MB, and lubricant as set forth below in Table 3. Mica had an average particle size of about 17-25 μm and thickness of less than 1 μm (aspect ratio of about 17 to 25), and Glass Flakes had a particle diameter of about 160 μm and a thickness of about 1.3 μm (aspect ratio of about 123).

TABLE 3
Formulations

| | Ex. 1 | Ex. 2 |
|---|---|---|
| LCP 2 | 54.3 | 54.3 |
| Milled Glass | 15 | 15 |
| Mica | 28 | — |
| Glass Flakes | — | 28 |
| Carbon Black MB | 2.5 | 2.5 |
| Lubricant | 0.2 | 0.2 |

Examples 1-2 were tested for certain thermal and mechanical properties. The results are set forth below in Table 4.

TABLE 4
Thermal and Mechanical Properties

| | Ex. 1 | Ex. 2 |
|---|---|---|
| Melt Viscosity at 1,000 s⁻¹ (Pa-s) | 20.3 | 19.1 |
| Charpy Notched Strength (kJ/m²) | 3.9 | 4.3 |
| Blister Free Temperature (° C.) | 265 | 265 |
| Tensile Strength (MPa) | 113.35 | 101.66 |
| Tensile Modulus (MPa) | 10,764 | 9,562 |
| Tensile Elongation (%) | 3.34 | 3.47 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition comprising flake-shaped particles distributed within a polymer matrix, wherein the flake-shaped particles have an aspect ratio of about 3 or more and the polymer matrix includes a thermotropic liquid crystalline polymer, wherein the polymer composition exhibits a melt viscosity of about 35 Pa-s or less as determined in accordance with ISO 11443:2021 at a shear rate of 1,000 seconds⁻¹ and temperature that is 15° C. higher than the melting temperature of the composition, and further wherein the polymer composition exhibits a tensile elongation of about 2.5% or more as determined in accordance with ISO 527:2019 at a temperature of 23° C.

2. The polymer composition of claim 1, wherein the composition exhibits a tensile strength of about 90 MPa or more as determined in accordance with ISO 527:2019 at a temperature of 23° C.

3. The polymer composition of claim 1, wherein the composition exhibits a tensile modulus of about 14,000 MPa or less as determined in accordance with ISO 527:2019 at a temperature of 23° C.

4. The polymer composition of claim 1, wherein the flaked-shaped particles have a nominal thickness of from about 0.1 to about 10 micrometers.

5. The polymer composition of claim 1, wherein the flake-shaped particles have an average diameter (D50) of from about 1 to about 300 micrometers.

6. The polymer composition of claim 1, wherein the flaked-shaped particles include glass.

7. The polymer composition of claim 1, wherein the flaked-shaped particles constitute from about 10 to about 80 parts by weight per 100 parts by weight of the polymer matrix.

8. The polymer composition of claim 1, wherein reinforcing fibers are also distributed within the polymer matrix.

9. The polymer composition of claim 8, wherein the reinforcing fibers include milled glass fibers.

10. The polymer composition of claim 1, wherein the polymer composition exhibits a deflection temperature under load of about 240° C. or more, as determined in accordance with ISO 75-2:2013 at 1.8 MPa.

11. The polymer composition of claim 10, wherein the polymer composition has a melting temperature of from about 300° C. to about 400° C. as determined in accordance with ISO 11357-3:2018.

12. The polymer composition of claim 11, wherein the ratio of the melting temperature to the deflection temperature under load is from about 0.7 to about 0.95.

13. The polymer composition of claim 1, wherein the composition exhibits a blister-free temperature of about 250° C. or more.

14. The polymer composition of claim 1, wherein liquid crystalline polymers constitute from about 20 wt. % to about 80 wt. % of the composition.

15. The polymer composition of claim 1, wherein the liquid crystalline polymer contains from 20 mol. % to about 60 mol. % of a repeating unit represented by Formula (I), from 0 mol. % to about 20 mol. % of a repeating unit represented by Formula (II), from about 5 mol. % to about 45 mol. % of a repeating unit represented by Formula (III), from about 5 mol. % to about 40 mol. % of a repeating unit represented by Formula (IV), and from 0 mol. % to about 15 mol. % of a repeating unit represented by Formula (V), 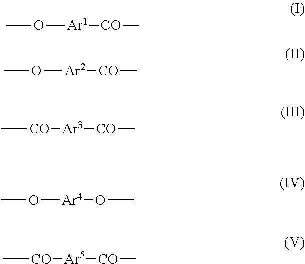
wherein Ar¹, Ar⁴, and Ar⁵ independently represent a phenyl or a biphenyl group, optionally substituted with a halogen atom, an alkyl group having 1 to 10 carbon atoms, or an aryl group having 6 to 20 carbon atoms, and further wherein Ar² and Ar³ independently represent a naphthenyl group optionally substituted with a halogen atom, an alkyl group having 1 to 10 carbon atoms, or an aryl group having 6 to 20 carbon atoms.

16. The polymer composition of claim 15, wherein the liquid crystalline polymer includes from 30 mol. % to about 50 mol. % of a repeating unit represented by Formula (I), from about 10 mol. % to about 40 mol. % of a repeating unit represented by Formula (III), from about 10 mol. % to about 35 mol. % of a repeating unit represented by Formula (IV), and from 2 mol. % to about 12 mol. % of a repeating unit represented by Formula (V).

17. The polymer composition of claim 15, wherein the molar ratio of the repeating unit represented by Formula (IV) to the total of repeating units represented by Formulas (IIII) and (V) is greater than 1.

18. The polymer composition of claim 15, wherein the total molar percentage of the repeating units represented by Formulae (I), (III), (IV), and (V) equals 100%.

19. The polymer composition of claim 1, wherein the liquid crystalline polymer is wholly aromatic.

20. The polymer composition of claim 1, wherein the polymer composition is free of flow modifiers.

21. An electrical connector that comprises opposing walls between which a passageway is defined for receiving a contact pin, wherein at least one of the walls contains the polymer composition of claim 1.
